(19) United States
(12) Patent Application Publication
(10) Pub. No.: US 2022/0345013 A1
(43) Pub. Date: Oct. 27, 2022

(54) ROTOR, TRACTION MOTOR, AND METHOD FOR MANUFACTURING ROTOR

(71) Applicant: NIDEC CORPORATION, Kyoto (JP)

(72) Inventor: Takahiro HIWA, Kyoto (JP)

(21) Appl. No.: 17/763,653

(22) PCT Filed: Sep. 11, 2020
(86) PCT No.: PCT/JP2020/034537

§ 371 Date: Mar. 25, 2022

(30) Foreign Application Priority Data
Sep. 30, 2019 (JP) 2019-179309

(51) Int. Cl. H02K 15/12; H02K 15/03; H02K 1/28; H02K 1/276

(52) U.S. Cl. CPC H02K 15/12; H02K 15/03; H02K 1/28; H02K 1/276

(57) ABSTRACT

A rotor rotates about an axis and includes: a core stack including core blocks stacked in tiers in an axial direction of the axis, each core block including steel plates stacked in the axial direction and having insertion holes arranged in a circumferential direction; magnets located within the insertion holes; and resin materials fixing the magnets inside the insertion holes. The core blocks adjacent to each other in the axial direction are angularly displaced from each other about the axis. The insertion holes of the core blocks adjacent to each other in the axial direction communicate with each other in the axial direction. Each of the resin materials includes a filling portion located within the insertion hole, a first gate located on a first side of the filling portion in the axial direction, and a second gate located on a second side of the filling portion in the axial direction.

### CROSS-REFERENCE TO RELATED APPLICATIONS

This is the U.S. national stage of application No. PCT/JP2020/034537, filed on Sep. 11, 2020, and priority under 35 U.S.C. § 119(a) and 35 U.S.C. § 365(b) is claimed from Japanese Patent Application No. 2019-179309, filed on Sep. 30, 2019.

### FIELD OF THE INVENTION

The present invention relates to a rotor. The present application claims priority based on Japanese Patent Application No. 2019-179309 filed in Japan on Sep. 30, 2019, the contents of which are incorporated herein by reference.

### BACKGROUND

A conventional rotor core is obtained by stacking a plurality of electromagnetic steel plates in an axial direction, and includes a plurality of permanent magnets embedded therein. The rotor core has a step skew structure in which the permanent magnets are displaced in the circumferential direction stepwise in relation to the axial direction.

In order to manufacture the step-skew rotor core, conventionally, an injection step for injecting an adhesive into a magnet insertion hole in a first tier, an insertion step for inserting a permanent magnet into the magnet insertion hole, and a filling step for filling the magnet insertion hole with the adhesive are sequentially performed. Then, after a stacking step for stacking the plurality of electromagnetic steel plates in the second tier so as to be displaced with respect to the electromagnetic steel plates in the first tier by a predetermined skew angle in a circumferential direction is performed, the injection step, the insertion step, and the filling step are performed on the magnet insertion hole in the second tier. According to the manufacturing method described above, it is possible to cover a wider range of the outer surfaces of the permanent magnets with the adhesive, whereby stress acting on the permanent magnets during high-speed rotation of the rotor core can be alleviated.

However, the conventional technique described above involves an increased number of work processes, because the adhesive is injected and filled for each tier. This causes a problem that the productivity of the rotor decreases.

### SUMMARY

In order to address the above problem, a rotor according to an embodiment is a rotor that rotates about a rotation axis, the rotor including: a core stack including a plurality of core blocks stacked in tiers in an axial direction of the rotation axis, each of the core blocks including a plurality of steel plates stacked in the axial direction and having a plurality of insertion holes arranged in a circumferential direction; a plurality of magnets located within the plurality of insertion holes; and a plurality of resin materials that fixes the magnets to the inside of the plurality of insertion holes, wherein the core blocks adjacent to each other in the axial direction are angularly displaced from each other about the rotation axis, the insertion holes of the core blocks adjacent to each other in the axial direction communicate with each other in the axial direction, and each of the resin materials includes a filling portion located within the insertion hole, a first gate located on a first side of the filling portion in the axial direction, and a second gate located on a second side of the filling portion in the axial direction.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view of a rotor according to a first embodiment;

FIG. 2 is a perspective view illustrating a first side of a resin material in an axial direction according to the first embodiment;

FIG. 3 is a perspective view illustrating a second side of the resin material in the axial direction according to the first embodiment;

FIG. 4 is a flowchart illustrating one example of a method for manufacturing the rotor according to the first embodiment;

FIG. 5 is a perspective view illustrating a mold in the first embodiment;

FIG. 6 is a longitudinal cross-sectional view of a traction motor according to a second embodiment;

FIG. 7 is a perspective view illustrating a first side of a rotor in an axial direction according to the second embodiment;

FIG. 8 is a perspective view illustrating a second side of the rotor in the axial direction according to the second embodiment;

FIG. 9 is a perspective view illustrating a first side of a core stack in the axial direction according to the second embodiment;

FIG. 10 is a perspective view illustrating a second side of the core stack in the axial direction according to the second embodiment;

FIG. 11 is a plan view illustrating a first core block on the first side in the axial direction;

FIG. 12 is a plan view illustrating a first end plate on the first side in the axial direction;

FIG. 13 is a plan view illustrating a second end plate on the second side in the axial direction;

FIG. 14 is a perspective view of a resin material in the second embodiment;

FIG. 15 is a flowchart illustrating a method for manufacturing the rotor according to the second embodiment;

FIG. 16 is a perspective view illustrating an example of a mold;

FIG. 17 is a diagram illustrating an inner surface of a second-side mold; and

FIG. 18 is a diagram illustrating a resin material formed in the mold.

### DETAILED DESCRIPTION

Embodiments of the present invention will now be described with reference to the accompanying drawings. Note that the components described in the following embodiments are merely examples, and the scope of the present invention is not intended to be limited thereto. In the drawings, the dimensions and the number of parts may be exaggerated or simplified as necessary for easy understanding.

In this application, a direction parallel to a rotation axis of a rotor is referred to as an “axial direction”, a direction perpendicular to the axial direction is referred to as a “radial direction”, and a direction along an arc about the rotation axis is referred to as a “circumferential direction”. In the radial direction, a direction approaching the rotation axis is referred to as an inside in the radial direction, a direction away from the rotation axis is referred to as an outside in the radial direction.

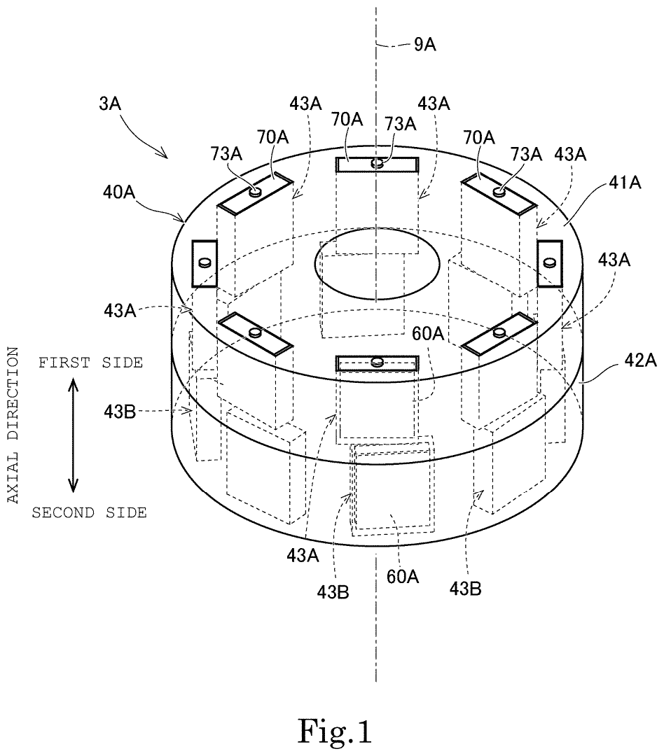

FIG. 1 is a perspective view of a rotor 3A according to a first embodiment. The rotor 3A rotates about a rotation axis 9A. The rotor 3A includes a core stack 40A. The core stack 40A is obtained by stacking a first core block 41A and a second core block 42A in tiers in the axial direction. Each of the core blocks 41A and 42A is formed by stacking a plurality of steel plates. In the core stack 40A, the first core block 41A is located at an end on a first side in the axial direction, and the second core block 42A is located at an end on a second side in the axial direction.

The first core block 41A has a plurality of insertion holes 43A arranged in the circumferential direction. Similar to the first core block 41A, the second core block 42A also has a plurality of insertion holes 43B arranged in the circumferential direction. A magnet 60A is located inside each of the insertion holes 43A and 43B. The magnet 60A is fixed by a resin material 70A inside each of the insertion holes 43A and 43B.

The core blocks 41A and 42A are adjacent to each other in the axial direction, and are angularly displaced from each other around the rotation axis 9A. That is, the core stack 40A has a skew structure. The insertion holes 43A and 43B communicate with each other in the axial direction. The wording “communicating with each other” herein means a state in which the insertion holes 43A and 43B are connected so that a fluid can flow therethrough.

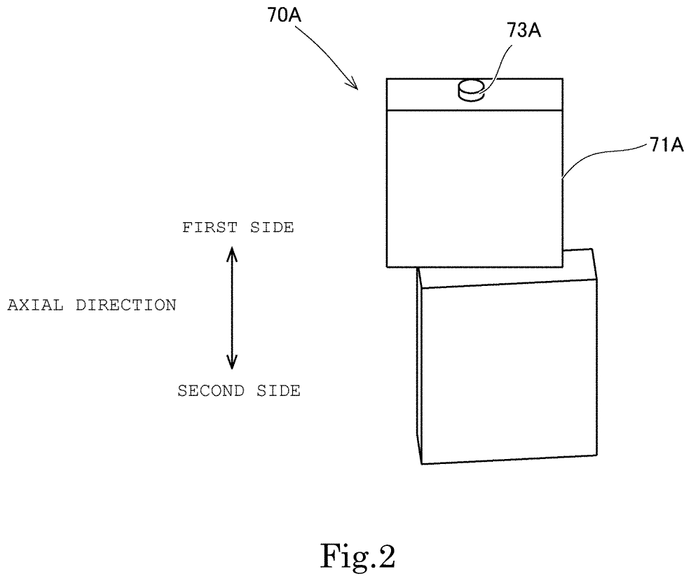

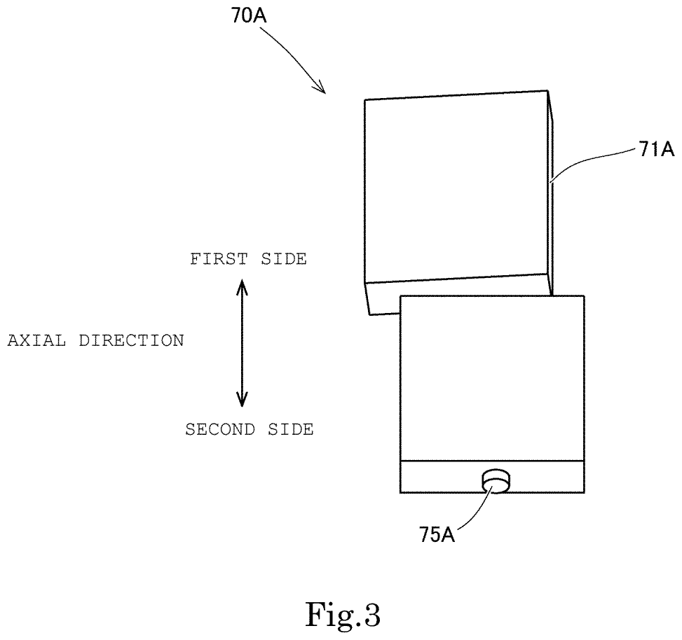

FIG. 2 is a perspective view illustrating a first side of the resin material 70A in the axial direction according to the first embodiment. FIG. 3 is a perspective view illustrating a second side of the resin material 70A in the axial direction according to the first embodiment. As illustrated in FIGS. 2 and 3, the resin material 70A includes a filling portion 71A positioned in the insertion holes 43A and 43B, a first gate 73A positioned on the first side in the axial direction of the filling portion 71A, and a second gate 75A positioned on the second side in the axial direction of the filling portion 71A.

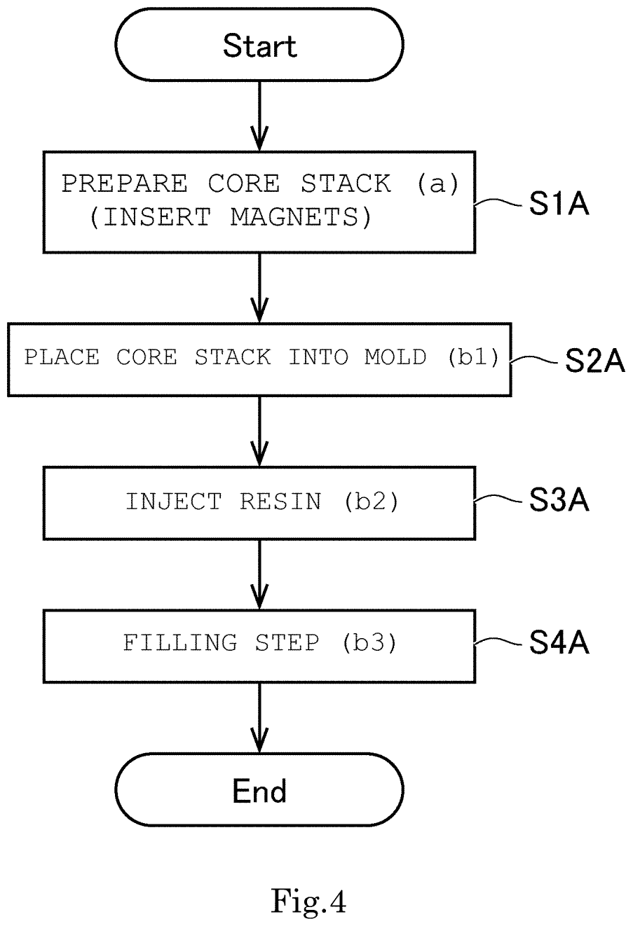

FIG. 4 is a flowchart illustrating one example of a method for manufacturing the rotor 3A according to the first embodiment. In order to manufacture the rotor 3A, first, a preparation step S1A for preparing the core stack 40A is performed. In the preparation step S1A, the core blocks 41A and 42A are produced by stacking a plurality of steel plates. Then, the first core block 41A is stacked on the first side in the axial direction of the second core block 42A so as to be displaced in the circumferential direction about the rotation axis 9A with respect to the second core block 42A. The magnet 60A is inserted into each of the insertion holes 43A and 43B of the core blocks 41A and 42A. When the core stack 40A is prepared in the preparation step S1A, a placement step S2A for placing the core stack 40A in a mold 80A is performed.

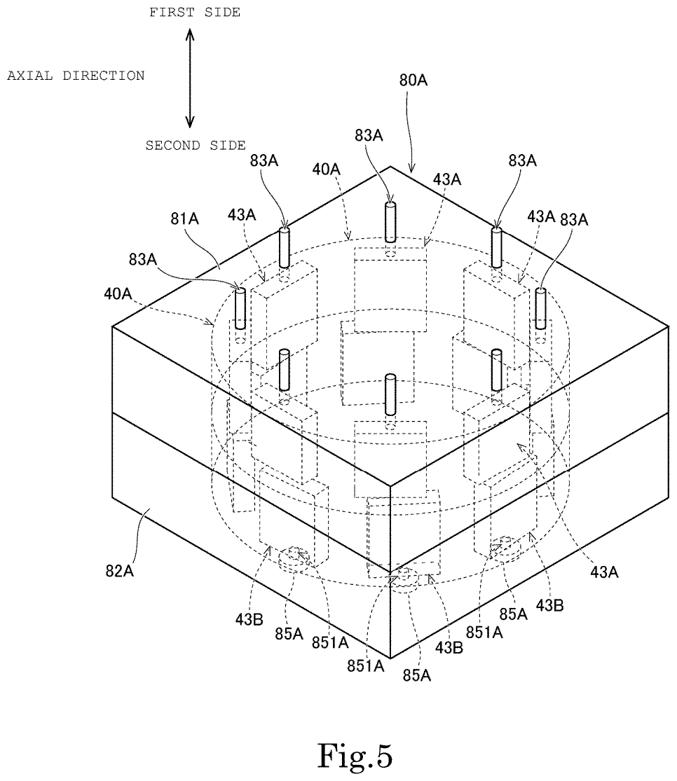

FIG. 5 is a perspective view illustrating the mold 80A in the first embodiment. As illustrated in FIG. 5, the mold 80 includes a first-side mold 81A and a second-side mold 82A. The first-side mold 81A and the second-side mold 82A have concave inner surfaces corresponding to the outer shape of the core stack 40A. The first-side mold 81A is provided with a plurality of (eight in this example) injection ports 83A. The injection ports 83A communicate with the insertion holes 43A of the first core block 41A, respectively. A plurality of (eight in this example) recessed outlets 851A are provided on the inner surface of the second-side mold 82A, and the outlets 851A communicate with resin reservoirs 85A provided inside the second-side mold 82A. When the core stack 40A is placed in the mold 80A, outlets 851A communicate with the insertion holes 43B of the second core block 42A, respectively.

Returning to FIG. 4, an injection step S3A is performed after the placement step S2A. In the injection step S3A, a fluid resin is injected into the injection ports 83A of the mold 80A illustrated in FIG. 5, so that the resin is injected into the insertion holes 43A and the insertion holes 43B respectively communicating with the insertion holes 43A.

Subsequently, a filling step S4A is performed. In the filling step S4A, the insertion holes 43A and 43B are filled with the fluid resin, while the fluid resin injected into the mold 80A in the injection step S3A is allowed to flow out from the insertion holes 43B to the resin reservoirs 85A via the outlets 851A.

The resin filled in the insertion holes 43A and 43B in the filling step S4A is cured, whereby the resin materials 70A are formed. In each resin material 70A, the first gate 73A is a part of a protrusion formed by the resin flowing into the insertion hole 43A through the injection port 83A. In addition, the second gate 75A is a part of a protrusion formed by the resin flowing out to the outlet 851A and the resin reservoir 85A.

According to the configuration of the rotor 3A and the method for manufacturing the rotor 3A, the insertion holes 43A and 43B which communicate with each other in the axial direction are filled with the resin at a time, whereby the number of steps can be reduced as compared with a case of performing filling of resin for each of the core blocks 41A and 42A. In addition, even if the resin partially unevenly flows through the insertion holes 43A and 43B during injection of the fluid resin through the injection ports 83A of the mold 80A, the resin which has previously moved can flow out to the resin reservoirs 85A through the insertion holes 43B via the outlets 851A. Thus, the fluid resin can be spread all over the inside of the insertion holes 43A and 43B, whereby a failure in filling the insertion holes 43A and 43B with resin can be suppressed. Therefore, productivity of the rotor 3A can be improved. In addition, the positions of the magnets 60A within the insertion holes 43A and 43B can be stabilized.

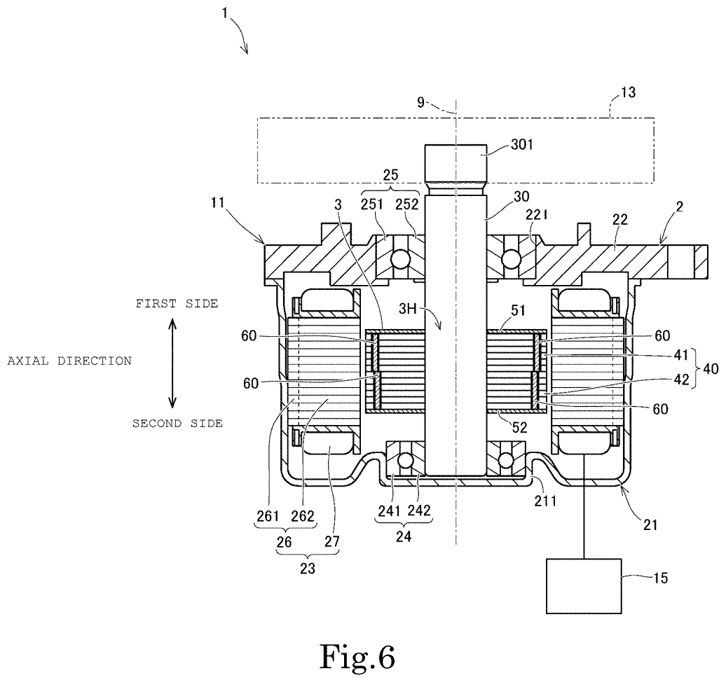

FIG. 6 is a longitudinal cross-sectional view of a traction motor 1 according to a second embodiment. The traction motor 1 is a device that is mounted on a vehicle such as an electric vehicle or a plug-in hybrid vehicle and outputs driving force for traveling the vehicle. The traction motor 1 includes a motor 11, a gear 13, and an inverter 15. The motor 11 has a stationary unit 2 and a rotor 3. The stationary unit 2 rotatably supports the rotor 3. The gear 13 is connected to the motor 11. The inverter 15 is electrically connected to the motor 11. The inverter 15 is a device that converts a direct current into an alternating current, and supplies a drive current obtained by the conversion to the motor 11.

The stationary unit 2 includes a housing 21, a cover 22, a stator 23, a first bearing 24, and a second bearing 25. The housing 21 is a bottomed hosing having a substantially cylindrical shape, and houses the stator 23, the first bearing 24, the rotor 3, and a shaft 30 therein. A recess 211 for holding the first bearing 24 is formed in the center of the bottom of the housing 21. The cover 22 is a plate-shaped member that closes an opening of the housing 21 on the first side in the axial direction. A circular hole 221 for holding the second bearing 25 is formed in the center of the cover 22.

The stator 23 generates a magnetic flux in response to a drive current. The stator 23 includes a stator core 26 and coils 27. The stator core 26 includes stacked steel plates obtained by stacking a plurality of steel plates in the axial direction. The stator core 26 includes an annular core back 261 and a plurality of teeth 262 which protrude to the inside in the radial direction from the core back 261. The core back 261 is fixed to the inner peripheral surface of a side wall of the housing 21. The coil 27 is configured by a wire wound around each tooth 262 of the stator core 26.

The first bearing 24 and the second bearing 25 are mechanisms that support the shaft 30 connected to a through hole 3H of the rotor 3 in a rotatable manner. In the present embodiment, a ball bearing in which an outer race and an inner race are rotated relative to each other through ball elements are used for the first bearing 24 and the second bearing 25. However, other types of bearing such as a slide bearing or liquid bearing can also be used.

An outer race 241 of the first bearing 24 is fixed to the recess 211 of the housing 21. In addition, an outer race 251 of the second bearing 25 is fixed to the edge of the circular hole 221 of the cover 22. On the other hand, inner races 242 and 252 of the first bearing 24 and the second bearing 25 are fixed to the shaft 30. Therefore, the shaft 30 is rotatably supported to the housing 21 and the cover 22.

The shaft 30 is a columnar member vertically extending along the rotation axis 9. The shaft 30 rotates about the rotation axis 9 while being supported on the first bearing 24 and the second bearing 25 described above. In addition, the shaft 30 includes a head portion 301 which protrudes to the first side in the axial direction from the cover 22. The head portion 301 is connected to an object to be steered of a vehicle through the gear 13 that is a power transmission mechanism. The rotor 3 rotates along with the shaft 30 on the inside of the stator 23 in the radial direction. The rotor 3 has a plurality of magnets 60 as will be described later.

In the motor 11, when a drive current is supplied to the coils 27 of the stator 23 from the inverter 15, a radial magnetic flux is generated at the plurality of teeth 262 of the stator core 26. In addition, a torque in the circumferential direction is generated by the action of the magnetic force between the teeth 262 and the magnets 60. As a result, the rotor 3 rotates about the rotation axis 9 with respect to the stator 23. When the rotor 3 rotates, a rotational driving force is transmitted to the gear 13 connected to the shaft 30.

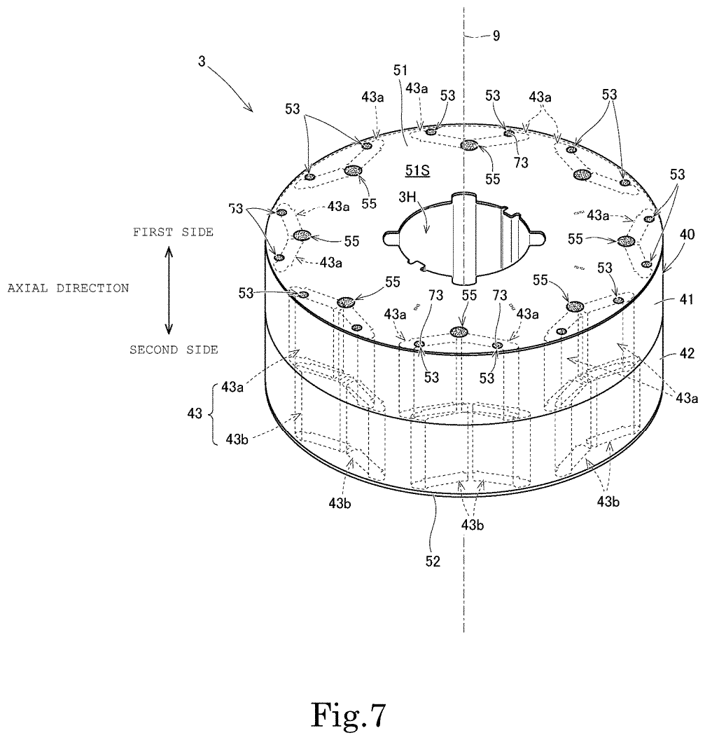

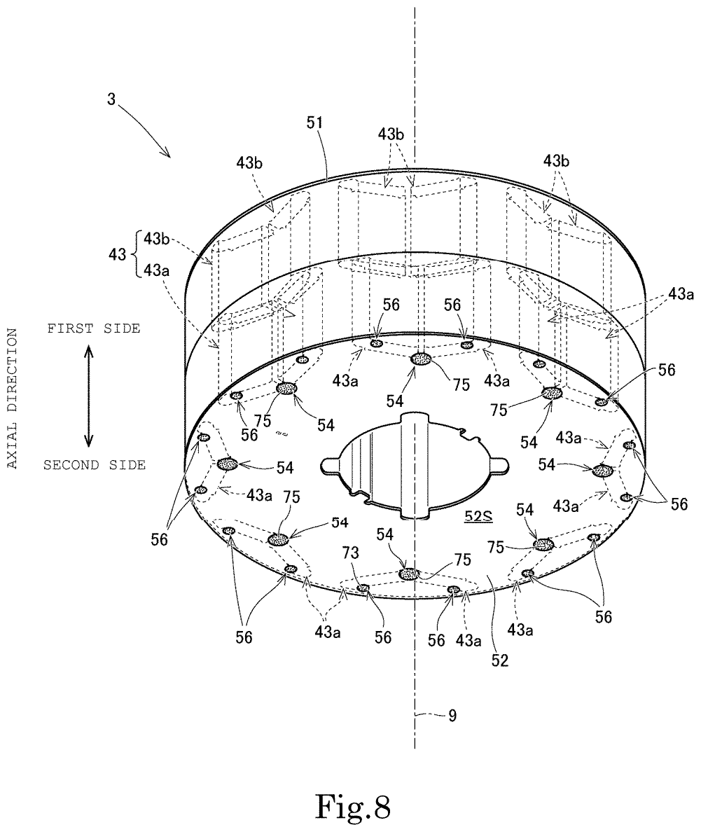

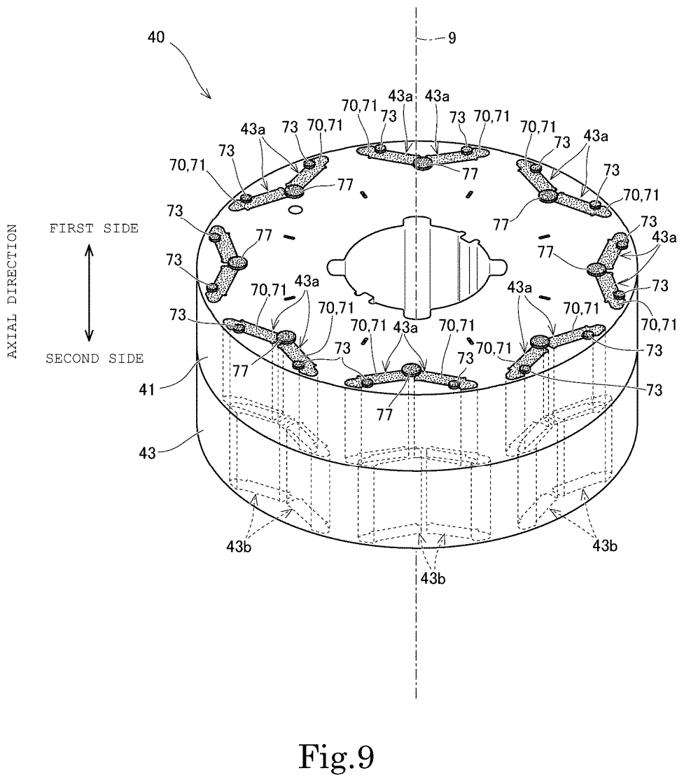

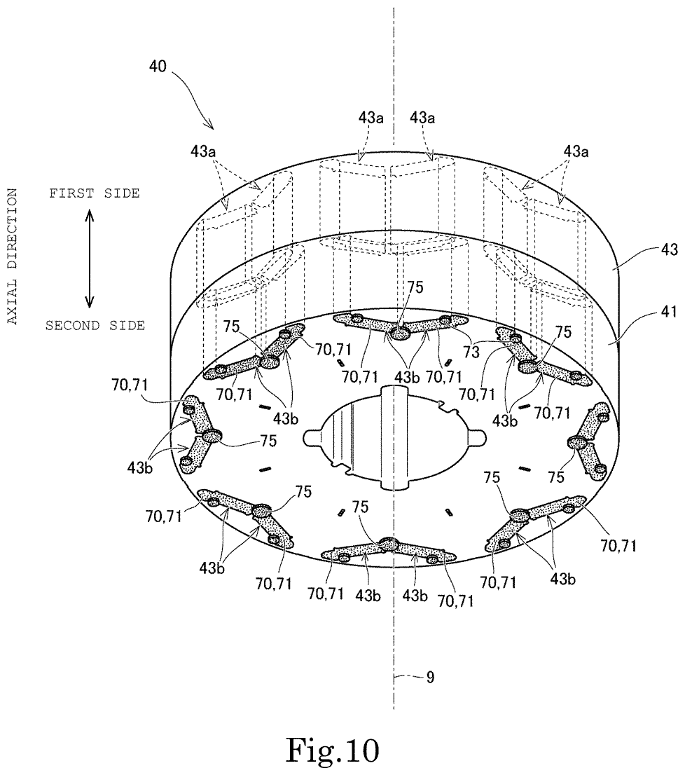

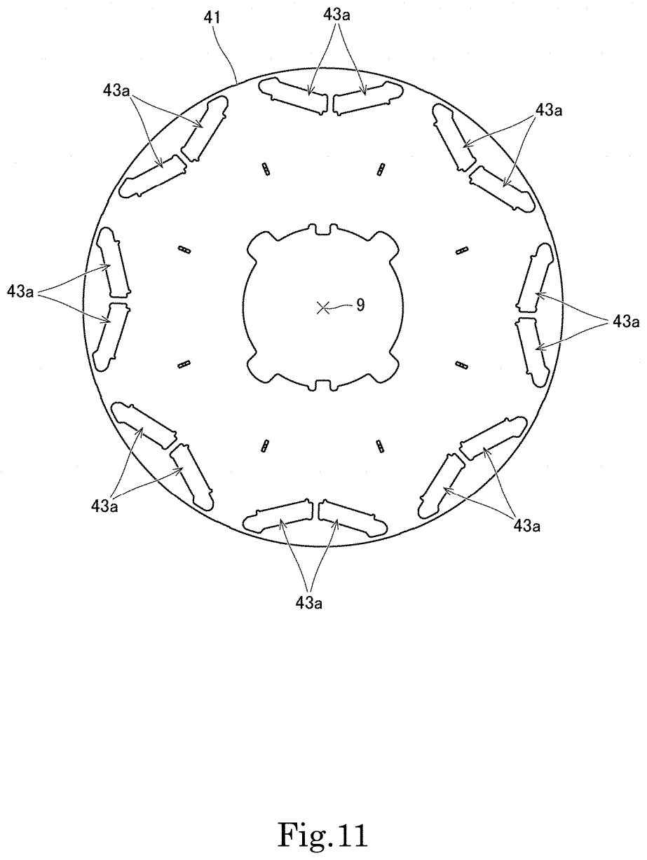

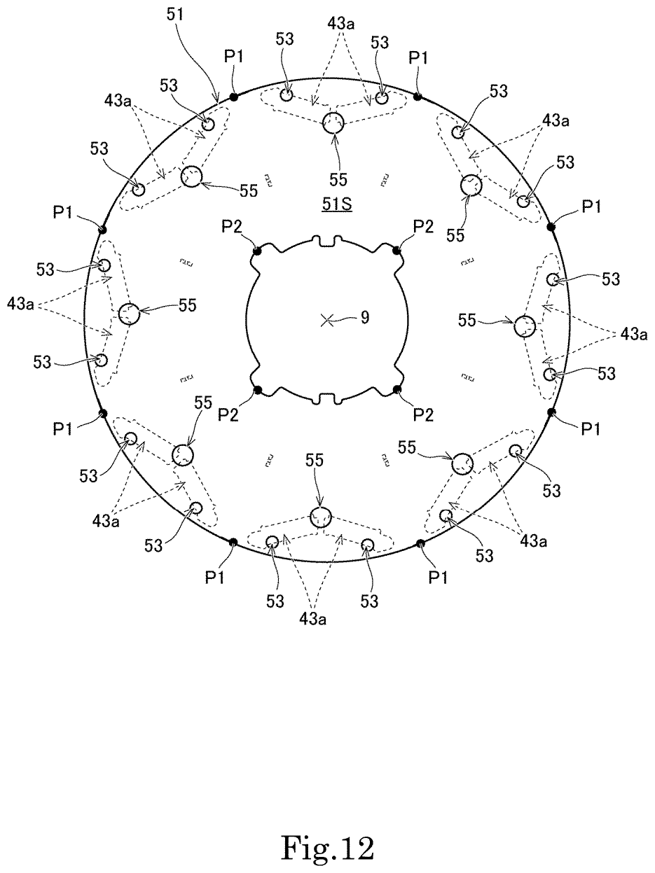

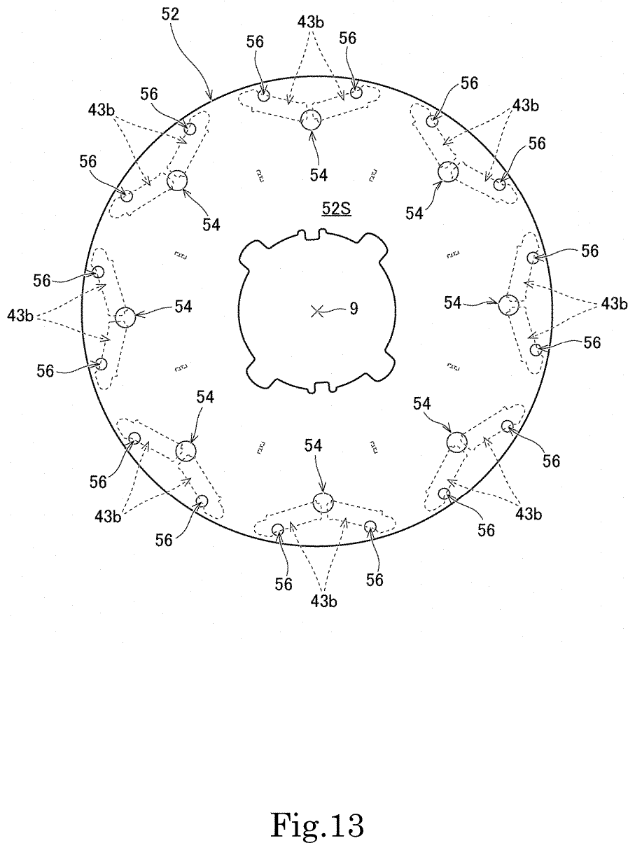

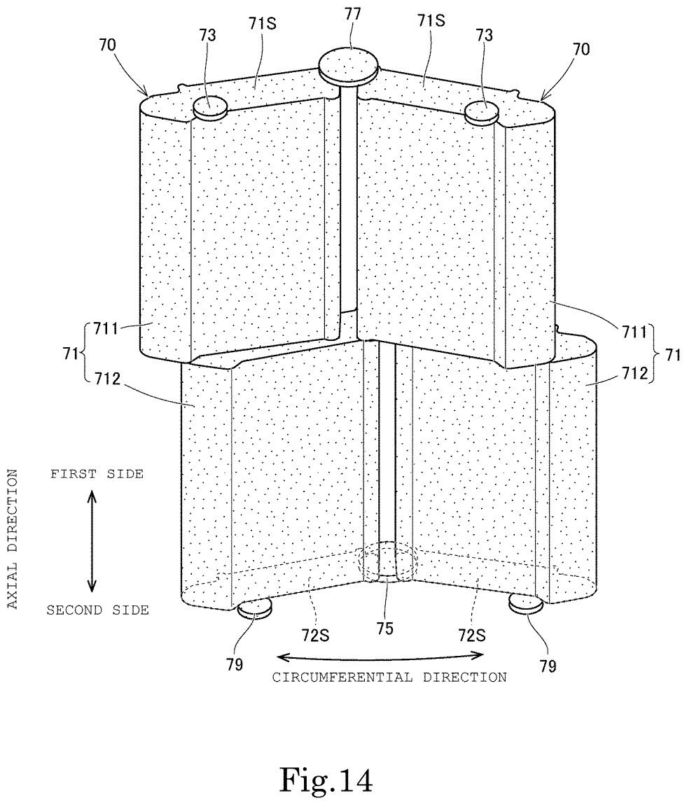

FIG. 7 is a perspective view illustrating a first side of the rotor 3 in the axial direction according to the second embodiment. FIG. 8 is a perspective view illustrating a second side of the rotor 3 in the axial direction according to the second embodiment. FIG. 9 is a perspective view illustrating a first side of a core stack 40 in the axial direction according to the second embodiment. FIG. 10 is a perspective view illustrating a second side of the core stack 40 in the axial direction according to the second embodiment. FIG. 11 is a plan view illustrating a first core block 41 on the first side in the axial direction. FIG. 12 is a plan view illustrating a first end plate 51 on the first side in the axial direction. FIG. 13 is a plan view illustrating a second end plate 52 on the second side in the axial direction. FIG. 14 is a perspective view of a resin material 70 in the second embodiment.

The rotor 3 includes the core stack 40, the first end plate 51, the second end plate 52, a plurality of magnets 60, and a plurality of resin materials 70. The core stack 40 is obtained by stacking two core blocks, a first core block 41 and a second core block 42, in the axial direction. Each of the core blocks 41 and 42 includes a plurality of substantially annular steel plates stacked in the axial direction.

The core blocks 41 and 42 have the same shape and size. The core blocks 41 and 42 are adjacent to each other in the axial direction, and are positioned to be angularly displaced from each other in the circumferential direction around the rotation axis 9. That is, the core stack 40 has a so-called skew structure. The angle of displacement (skew angle) of the second core block 42 relative to the first core block 41 is, for example, 3.25°.

The first core block 41 has 16 insertion holes 43a arranged in the circumferential direction. More specifically, the first core block 41 has eight sets of a pair of insertion holes 43a and 43a, which are close to each other in the circumferential direction, at equal intervals in the circumferential direction. The pair of insertion holes 43a and 43a is adjacent to each other at an interval in the circumferential direction when viewed in the axial direction, and is formed into a V shape in which the insertion holes 43a and 43a are separated from each other in the circumferential direction as they extend toward the outside in the radial direction.

Similar to the first core block 41, the second core block 42 also has 16 insertion holes 43b arranged in the circumferential direction. More specifically, the second core block 42 has eight sets of a pair of insertion holes 43b and 43b, which are close to each other in the circumferential direction, at equal intervals in the circumferential direction. Similar to the pair of insertion holes 43a and 43a, the pair of insertion holes 43b and 43b is also formed into a V shape when viewed in the axial direction. The insertion holes 43a and 43b have the same shape and size.

The insertion holes 43a and 43b are through holes having a constant opening shape in the axial direction. The insertion holes 43a and 43b communicate with each other in the axial direction. That is, as illustrated in FIGS. 7 and 8, the insertion hole 43a and the insertion hole 43b constitute one continuous hole 43.

One magnet 60 is placed in each of the insertion holes 43a and 43b. The pair of insertion holes 43a and 43a and the pair of insertion holes 43b and 43b are formed into a V shape, so that a pair of magnets 60 is placed in a V shape. Accordingly, the magnetic characteristics of the rotor 3 can be improved. The magnets 60 are placed each in the pair of insertion holes 43a and 43a such that the magnetic poles of the surfaces facing outward in the radial direction are the same. The magnets 60 placed in another pair of insertion holes 43a and 43a adjacent to the pair of insertion holes 43a and 43a in the circumferential direction are placed such that magnetic poles of surfaces facing outward in the radial direction are different. The same applies to the pair of insertion holes 43b and 43b. The magnet 60 is fixed by the resin material 70 to be described later inside each of the insertion holes 43a and 43b.

The end plates 51 and 52 are the same member having a substantially annular plate shape. As illustrated in FIG. 12, the first end plate 51 includes multiple (16 in this example) first connection holes 53 that are first through holes and multiple (8 in this example) third connection holes 55 that are second through holes. As illustrated in FIG. 13, the second end plate 52 also includes multiple (16 in this example) fourth connection holes 56 that are first through holes and multiple (8 in this example) second connection holes 54 that are second through holes. In the first end plate 51, the multiple first connection holes 53 are located on the same circumference, and the multiple third connection holes 55 are located on the same circumference at equal intervals. In the second end plate 52, the multiple fourth connection holes 56 are also located on the same circumference, and the multiple second connection holes 54 are also located on the same circumference at equal intervals.

As illustrated in FIG. 7, the first end plate 51 is located on the first side of the core stack 40 in the axial direction. The first end plate 51 faces the plurality of magnets 60 placed in the insertion holes 43a in the axial direction, and prevents the magnets 60 from falling off from the insertion holes 43a to the first side in the axial direction. In addition, as illustrated in FIGS. 7 and 12, the first connection holes 53 of the first end plate 51 communicate with the insertion holes 43a of the first core block 41. Due to the first end plate 51 having the first connection holes 53, the resin materials 70 can be filled from the first side of the continuous holes 43 in the axial direction after the first end plate 51 is attached to the core stack 40.

As illustrated in FIG. 8, the second end plate 52 is located on the second side of the core stack 40 in the axial direction. The second end plate 52 faces the plurality of magnets 60 placed in the insertion holes 43b in the axial direction, and prevents the magnets 60 from falling off from the insertion holes 43b to the second side in the axial direction. As illustrated in FIGS. 8 and 13, the second connection holes 54 of the second end plate 52 communicate with the insertion holes 43b of the second core block 42. Due to the second end plate 52 having the second connection holes 54, the resin materials 70 can flow out from the second side of the continuous holes 43 in the axial direction after the second end plate 52 is attached to the core stack 40.

The core block 41 is provided with pairs of insertion holes 43a and 43a close to each other in the circumferential direction, and the core block 42 is provided with pairs of insertion holes 43b and 43b close to each other in the circumferential direction. Therefore, in the rotor 3, the pair of resin materials 70 is disposed so as to be close to each other in the circumferential direction as illustrated in FIG. 14. Each of the resin materials 70 includes a filling portion 71, a first gate 73, and a second gate 75. The filling portion 71 is located inside the insertion holes 43a and 43b (that is, the continuous hole 43) communicating with each other in the axial direction. More specifically, the filling portion 71 includes a first filling portion 711 located inside the insertion hole 43a and a second filling portion 712 located inside the insertion hole 43b. The first gate 73 is located on the first side in the axial direction of the filling portion 71. In this example, the first gate 73 is a protrusion protruding to the first side in the axial direction from a first end surface 71S of the first filling portion 711 on the first side in the axial direction. The first gate 73 is a portion placed inside the first connection hole 53 as illustrated in FIG. 7. An end of the first gate 73 on the first side in the axial direction is located further to the second side in the axial direction than the end surface 51S of the first end plate 51 on the first side in the axial direction. The first gate 73 does not protrude from the first end plate 51 in the axial direction, which can prevent contact between the first gate 73 and another member.

The second gate 75 is located on the second side in the axial direction of the filling portion 71. The second gate 75 is a protrusion protruding to the second side in the axial direction from a second end surface 72S of the second filling portion 712 on the second side in the axial direction. The second gate 75 is a portion placed inside the second connection hole 54 as illustrated in FIG. 8. An end of the second gate 75 on the second side in the axial direction is located further to the first side in the axial direction than the end surface 52S of the second end plate 52 on the second side in the axial direction. The second gate 75 does not protrude from the second end plate 52 in the axial direction, which can prevent contact between the second gate 75 and another member.

When the resin materials 70 are formed, resin is injected into the first connection holes 53 of the first end plate 51. Then, the resin flows into the insertion holes 43a of the first core block 41 and the insertion holes 43b of the second core block 42 through the first connection holes 53. A part of the resin flows out from the insertion holes 43b through the second connection holes 54. As illustrated in FIG. 13, each of the second connection holes 54 is disposed at a position overlapping both of the pair of insertion holes 43b and 43b in the axial direction. Therefore, as illustrated in FIG. 14, a pair of filling portions 71 and 71 (more specifically, the pair of second filling portions 712 and 712) close to each other in the circumferential direction is connected by one second gate 75 formed in the second connection hole 54.

As illustrated in FIG. 12 or 13, the second connection holes 54 in the second end plate 52 are located closer to the rotation axis 9 than the first connection holes 53 in the first end plate 51. Therefore, the second gates 75 located in the second connection holes 54 are located closer to the rotation axis 9 than the first gates 73 provided in the first connection holes 53. As a result, the resin flows through the continuous holes 43 from the outside toward the inside in the radial direction. Therefore, the magnets 60 can be fixed while being pressed against the radially inner surfaces of the continuous holes 43, whereby the magnets 60 can be stably placed in the continuous holes 43.

As illustrated in FIG. 14, the second gate 75 provided in the pair of resin materials 70 and 70 is positioned between the pair of first gates 73 and 73 respectively included in the pair of resin materials 70 and 70 in the circumferential direction.

As illustrated in FIG. 12, the third connection holes 55 of the first end plate 51 communicate with pairs of insertion holes 43a and 43a adjacent in the circumferential direction. That is, each third connection hole 55 is provided to extend across the pair of insertion holes 43a and 43a. The third connection holes 55 are provided to release a gas generated from the resin through the insertion holes 43a when the continuous holes 43 are filled with the resin. As illustrated in FIG. 14, a protrusion 77 is formed on the first end surface 71S of the resin material 70 by the third connection hole 55. In this example, the pair of resin materials 70 and 70 (more specifically, the pair of first filling portions 711 and 711) close to each other in the circumferential direction is connected by one protrusion 77 provided on the first side in the axial direction. The protrusion 77 located in the third connection hole 55 is located closer to the rotation axis 9 than the first gates 73 provided in the first connection holes 53. With this configuration, an increase in size in the radial direction of the protrusion 77 can be suppressed, whereby an amount of the resin materials 70 used can be reduced.

As illustrated in FIG. 13, the fourth connection holes 56 of the second end plate 52 communicate with the insertion holes 43b of the second core block 42. When the continuous hole 43 is filled with the resin, a protrusion 79 is formed on the resin material 70 by the fourth connection hole 56 as illustrated in FIG. 14. The protrusion 79 is provided on the second end surface 72S of the filling portion 71.

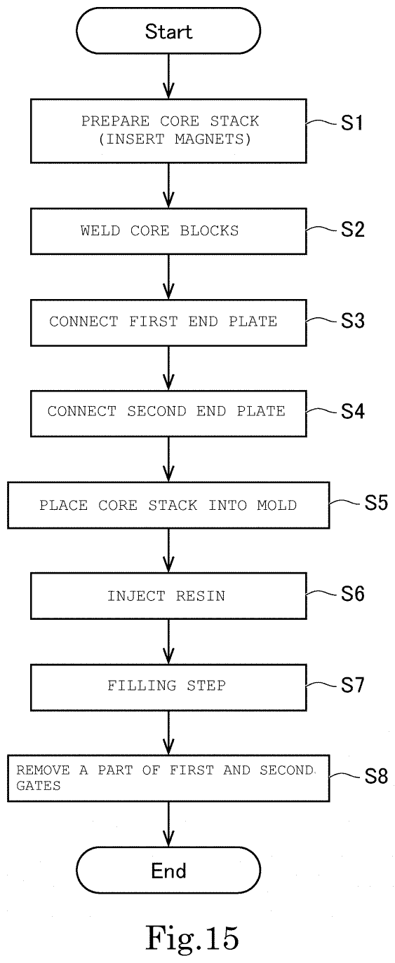

FIG. 15 is a flowchart illustrating a method for manufacturing the rotor 3 according to the second embodiment. In order to manufacture the rotor 3, first, a preparation step S1 for preparing the core stack 40 is performed. In the preparation step S1, the core blocks 41 and 42 are stacked in tiers in the axial direction. The core blocks 41 and 42 adjacent to each other in the axial direction are placed while being angularly displaced from each other around the rotation axis 9, and the insertion holes 43a and 43b of the core blocks 41 and 42 adjacent to each other in the axial direction communicate with each other in the axial direction. The preparation step S1 includes a magnet insertion step for inserting the magnet 60 into each of the insertion holes 43a and 43b.

Following the preparation step S1, a first welding step S2 for welding the core blocks 41 and 42, a second welding step S3 for welding the first end plate 51 to the first core block 41, and a third welding step S4 for welding the second end plate 52 to the second core block 42 are performed. As a result, a stack including the first end plate 51, the core blocks 41 and 42, and the second end plate 52 is formed.

In the first, second, and third welding steps S2 to S4, the welding position is not particularly limited. As an example, when the first end plate 51 and the first core block 41 are welded, they may be welded at a plurality of (eight in the illustrated example) welding positions P1 distributed in the circumferential direction on the outer peripheral portion of the first end plate 51 as illustrated in FIG. 12. In addition, they may be welded at a plurality of (four in the illustrated example) welding positions P2 distributed in the circumferential direction on the inner peripheral portion of the first end plate 51.

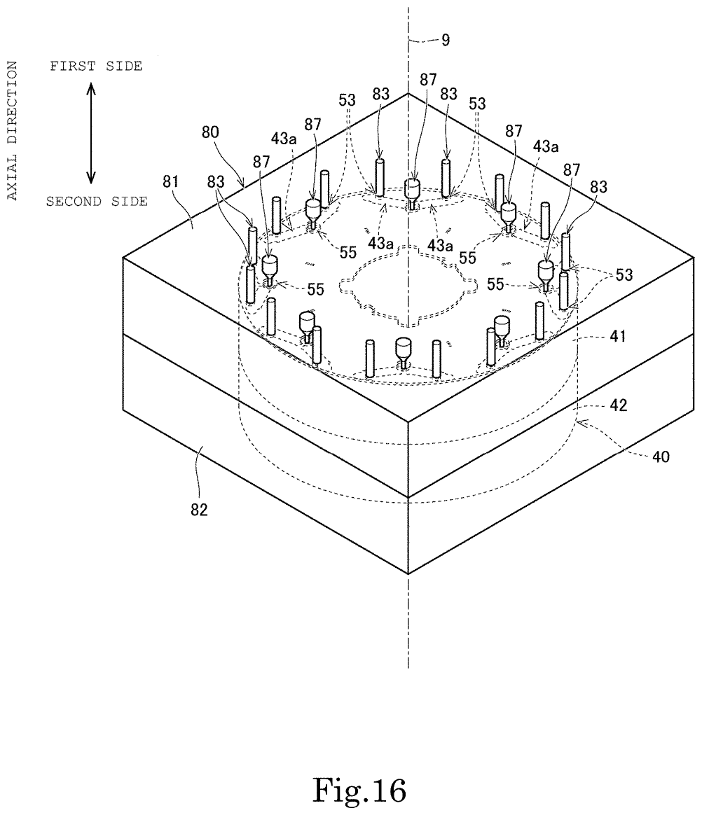

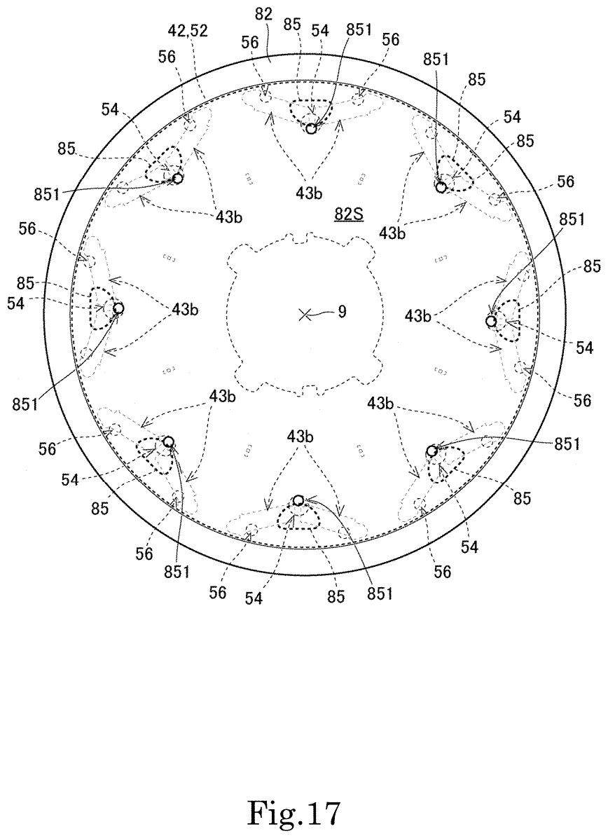

Following the first, second, and third welding steps S2 to S4, a placement step S5 for placing the core stack 40 in the mold 80 is performed. FIG. 16 is a perspective view illustrating an example of the mold 80. FIG. 17 is a diagram illustrating an inner surface 82S of a second-side mold 82. In FIG. 16, the core stack 40 is indicated by a broken line. In FIG. 17, the second core block 42 and the second end plate 52 are indicated by a broken line.

The mold 80 includes a first-side mold 81 located on the first side in the axial direction and the second-side mold 82 located on the second side in the axial direction. Each of the first-side mold 81 and the second-side mold 82 may be obtained by combining a plurality of members. As illustrated in FIG. 16, the first-side mold 81 is provided with a plurality of (16 in this example) injection ports 83. When the core stack 40 is placed in the mold 80, the injection ports 83 respectively communicate with the insertion holes 43a of the first core block 41 via the first connection holes 53 of the first end plate 51.

As shown in FIG. 17, the inner surface 82S of the second-side mold 82 is provided with a plurality of (eight in this example) outlets 851. The outlets 851 communicate with resin reservoirs 85 provided inside the second-side mold 82. When the core stack 40 is placed in the mold 80, the second connection holes 54 of the second end plate 52 overlap the outlets 851 in the axial direction. Thus, the resin reservoirs 85 communicate with the insertion holes 43b of the second core block 42 via the outlets 851 and the second connection holes 54. The fourth connection holes 56 of the second end plate 52 are closed by the inner surface 82S of the second-side mold 82.

As illustrated in FIG. 16, the first-side mold 81 is provided with a plurality of (eight in this example) release ports 87. When the core stack 40 is placed in the mold 80, the release ports 87 communicate with the insertion holes 43a of the first core block 41 via the third connection holes 55. It is desirable that each release port 87 has a diameter large enough to allow passage of gas generated from the resin and to inhibit passage of the resin. With this configuration, the resin does not flow out from the release ports 87, and generation of burrs can be suppressed. The diameter of the release port 87 on the second side in the axial direction is preferably smaller than the diameter of the injection port 83 on the second side in the axial direction.

Following the placement step S5, an injection step S6 for injecting a fluid resin into the injection ports 83 is performed. In this example, resin is injected into the 16 injection ports 83 almost simultaneously. Note that it is not necessary to simultaneously inject the resin into all the injection ports 83.

Following the injection step S6, a filling step S7 for filling the continuous holes 43 with the fluid resin is performed. Through the filling step S7, the gaps between the inner peripheral surfaces of the insertion holes 43a and the magnets 60 and the gaps between the inner peripheral surfaces of the insertion holes 43b and the magnets 60 are filled with the resin.

The gaps between the insertion holes 43a and 43b and the magnets 60 are not uniform, and thus, there is a portion where the flow path area of the resin is narrowed in each continuous hole 43. Therefore, it is difficult to uniformly move the resin toward the second side in the axial direction inside the continuous holes 43. Therefore, even if the resin moves to the end of each insertion hole 43b on the second side in the axial direction, a portion not filled with the resin may occur in each continuous hole 43.

In the filling step S7, the fluid resin injected into the mold 80 is allowed to flow out to the resin reservoirs 85 via the outlets 851 provided in the second-side mold 82. As a result, even if the resin partially unevenly moves in the continuous holes 43, the resin that has previously moved to the second side in the axial direction can flow out from the continuous holes 43 to the resin reservoirs 85 through the outlets 851 of the mold 80. Thus, the inside of the continuous holes 43 can be satisfactorily filled with the resin.

In particular, the core stack 40 has a skew structure, and thus, the pair of insertion holes 43a and 43a close to each other in the circumferential direction and the pair of insertion holes 43b and 43b close to each other in the circumferential direction are disposed to be displaced from each other in the circumferential direction. Therefore, the insertion holes 43a and 43a differ in shape and size of overlap between the pair of insertion holes 43a and 43a and the pair of insertion holes 43b and 43b. Due to this difference in overlap, a difference in filling rate may occur between the pair of continuous holes 43.

In the present embodiment, even if there is a difference in filling rate of the resin between the pair of continuous holes 43 and 43, the resin with a higher filling rate can flow out to the resin reservoir 85 through the outlet 851. Thus, the resin can be satisfactorily distributed in both of the pair of continuous holes 43 and 43.

In addition, the resin moving through the pair of continuous holes 43 and 43 can flow out to the resin reservoir 85 through the second connection hole 54 communicating with both of the pair of continuous holes 43 and 43. Therefore, an amount of resin flowing out can be reduced as compared with the case where the second connection hole 54 is provided for each continuous hole 43.

In the filling step S7, when gas is generated from the resin injected into the continuous holes 43, the gas is released to the outside of the mold 80 through the release ports 87 communicating with the insertion holes 43a. This makes it possible to suppress filling failure of resin due to gas filling.

When the filling step S7 is completed, the resin is cured by cooling, and then, the core stack 40 is removed from the mold 80. Subsequently, a removal step S8 for removing a part of the first gates 73 and the second gates 75 from the core stack 40 is performed.

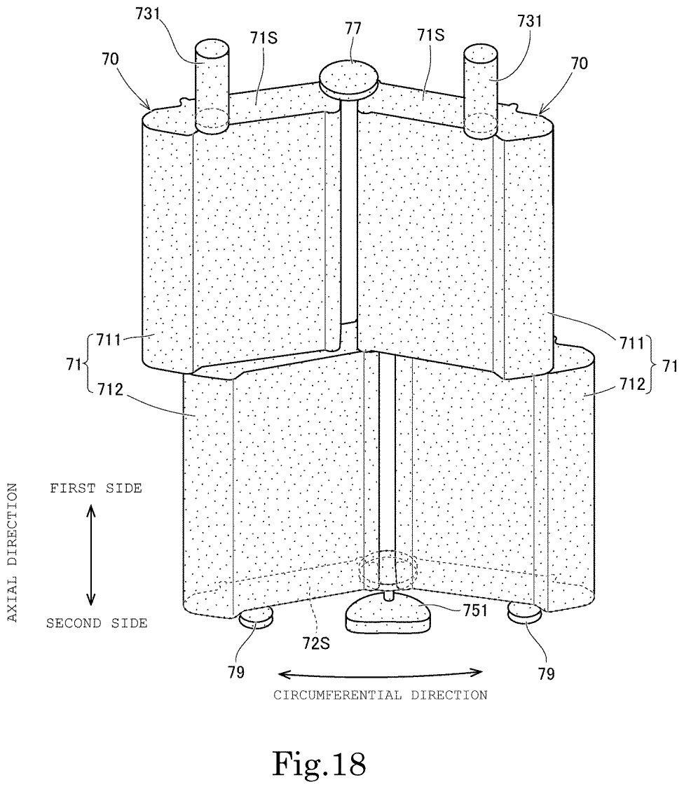

FIG. 18 is a diagram illustrating the resin material 70 formed in the mold 80. As illustrated in FIG. 18, the resin material 70 formed in the mold 80 has a first gate 731 having a shape corresponding to the injection port 83 and a second gate 751 having a shape corresponding to the outlet 851 and the resin reservoir 85. The first gate 731 has a portion protruding from the first connection hole 53. In the removal step S8, the first gate 73 illustrated in FIG. 14 is formed by removing the portion of the first gate 731 protruding from the first connection hole 53. The second gate 751 illustrated in FIG. 18 has a portion protruding from the second connection hole 54. In the removal step S8, the second gate 75 illustrated in FIG. 14 is formed by removing the portion of the second gate 751 protruding from the second connection hole 54.

According to the configuration of the rotor 3 and the method for manufacturing the rotor 3, the insertion holes 43a and 43b which communicate with each other in the axial direction are filled with the resin at a time, whereby the number of steps can be reduced as compared with the case of performing filling of resin for each of the core blocks 41 and 42. In addition, even if the resin partially unevenly flows through the continuous holes 43 during injection of the fluid resin through the injection ports 83 of the mold 80, the resin that has previously moved can flow out to the resin reservoirs 85 through the insertion holes 43b via the outlets 851. Thus, the fluid resin can be spread all over the inside of the insertion holes 43a and 43b, whereby a failure in filling the insertion holes 43a and 43b with resin can be suppressed. Therefore, productivity of the rotor 3 can be improved. In addition, the positions of the magnets 60 within the insertion holes 43a and 43b can be stabilized.

In addition, welding between the core blocks 41 and 42 of the core stack 40, welding between the core stack 40 and the first end plate 51, and welding between the core stack 40 and the second end plate 52 can be performed at a time. Accordingly, the productivity of the traction motor 1 can be improved.

Further, the end plates 51 and 52 are the members having the same shape, whereby the second end plate 52 can be obtained by turning the first end plate 51 upside down. This eliminates the need to individually manufacture the end plates 51 and 52. In addition, when the end plates 51 and 52 are plate members having the same shape and provided with first through holes (connection holes 53 and 56) and second through holes (connection holes 55 and 54), it is possible to fill the insertion holes 43a and 43b of the core stack 40 with resin after the end plates 51 and 52 are attached to the core stack 40.

While the embodiments have been described above, the present invention is not limited to the embodiments, and various modifications are possible.

For example, although the core stack 40 includes the two core blocks 41 and 42, one or more core blocks may be provided between the core blocks 41 and 42. That is, the core stack 40 may have a configuration in which core blocks are stacked in three or more tiers.

Further, it is not necessary to connect the first end plate 51, the core blocks 41 and 42, and the second end plate 52 by welding, and they may be connected by other means such as crimping or screwing.

While the present invention has been described above in detail, the above description is illustrative in all respects, and the invention is not limited thereto. It is therefore understood that numerous modifications and variations can be conceived of without departing from the scope of the invention. The components described in the embodiments and the modifications described above may be combined together or omitted, as appropriate, as long as there is no inconsistency.

The present invention can be used for a rotor.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A rotor that rotates about a rotation axis, the rotor comprising:
a core stack including a plurality of core blocks stacked in tiers in an axial direction of the rotation axis, each of the core blocks including a plurality of steel plates stacked in the axial direction and having a plurality of insertion holes arranged in a circumferential direction;
a plurality of magnets located within the plurality of insertion holes; and
a plurality of resin materials that fixes the magnets to the inside of the plurality of insertion holes, wherein
the core blocks adjacent to each other in the axial direction are angularly displaced from each other about the rotation axis,
the insertion holes of the core blocks adjacent to each other in the axial direction communicate with each other in the axial direction, and
each of the resin materials includes a filling portion located within the insertion hole,
a first gate located on a first side of the filling portion in the axial direction, and
a second gate located on a second side of the filling portion in the axial direction.

2. The rotor according to claim 1, wherein each of the first gates is a protrusion protruding to the first side in the axial direction from a first end surface of the filling portion on the first side in the axial direction.

3. The rotor according to claim 1, wherein each of the second gates is a protrusion protruding to the second side in the axial direction from a second end surface of the filling portion on the second side in the axial direction.

4. The rotor according to claim 1, wherein the plurality of insertion holes includes a pair of insertion holes that is close to each other in the circumferential direction and is formed into a V shape in which the pair of insertion holes is separated from each other in the circumferential direction as the pair of insertion holes extends to an outside in a radial direction.

5. The rotor according to claim 4, wherein
the second gates are located closer to the rotation axis than the first gates,
the plurality of resin materials includes a pair of resin materials located within the pair of insertion holes, and
the second gate provided to the pair of resin materials is located between a pair of first gates of the pair of resin materials in the circumferential direction.

6. The rotor according to claim 1, further comprising a first end plate that is located on a first side of the core stack in the axial direction, the first end plate having a first connection hole communicating with the insertion holes of a first core block located at an end on the first side in the axial direction among the core blocks stacked in tiers, wherein
the first gates communicate with the first connection hole in the axial direction.

7. The rotor according to claim 6, wherein ends of the first gates on the first side in the axial direction are located further to the second side in the axial direction than an end surface of the first end plate on the first side in the axial direction.

8. The rotor according to claim 1, further comprising a second end plate that is located on a second side of the core stack in the axial direction, the second end plate having a second connection hole communicating with the insertion holes of a second core block located at an end on the second side in the axial direction among the core blocks stacked in tiers, wherein
the second gates communicate with the second connection hole in the axial direction.

9. The rotor according to claim 8, wherein ends of the second gates on the second side in the axial direction are located further to the first side in the axial direction than an end surface of the second end plate on the second side in the axial direction.

10. The rotor according to claim 8, wherein the second connection hole communicates with two insertion holes close to each other in the circumferential direction in the second core block.

11. The rotor according to claim 7, further comprising a second end plate that is located on a second side of the core stack in the axial direction, the second end plate having a second connection hole communicating with the insertion holes of a second core block located at an end on the second side in the axial direction among the core blocks stacked in tiers, wherein
the second gates communicate with the second connection hole in the axial direction, and
the first end plate is the same in shape as the second end plate.

12. The rotor according to claim 1, wherein the first end plate further includes a third connection hole communicating with the insertion holes of the first core block.

13. The rotor according to claim 12, wherein the third connection hole is located closer to the rotation axis than the first connection hole.

14. The rotor according to claim 12, wherein each of the resin materials has a protrusion protruding to the first side in the axial direction from the filling portion and located within the third connection hole.

15. A traction motor comprising:
a motor including the rotor according to claim 1 and a stator that supports the rotor in a rotatable manner;
a gear connected to the motor; and
an inverter electrically connected to the motor.

16. A method for manufacturing a rotor that rotates about a rotation axis, the method comprising:
(a) a step for preparing a core stack that includes a plurality of core blocks stacked in tiers in an axial direction of the rotation axis, each of the core blocks including a plurality of steel plates stacked in the axial direction and having a plurality of insertion holes arranged in a circumferential direction, the core blocks adjacent to each other in the axial direction being angularly displaced from each other about the rotation axis with the insertion holes of the core blocks communicating with each other in the axial direction; and
(b) a step for forming a plurality of resin materials that fixes a magnet to an inside of the plurality of insertion holes of the core stack, wherein
the step (b) includes
(b1) a step for placing the core stack into a mold including a first-side mold and a second-side mold,
(b2) a step for injecting a fluid resin into an injection port that is provided in the first-side mold and that communicates with the insertion holes of a first core block located on an end on the first side in the axial direction among the core blocks stacked in tiers, the step (b2) being performed after the step (b1), and
(b3) a step for filling the insertion holes with the fluid resin injected into the mold in the step (b2), while allowing the fluid resin to flow out to a resin reservoir that is provided in the second-side mold and that communicates with the insertion holes of a second core block located on an end on the second side in the axial direction among the plurality of core blocks stacked in tiers.

17. The method for manufacturing a rotor according to claim 16, further comprising:
(c) a step for inserting the magnet in the insertion holes before the step (b2); and
(d) a removal step for removing at least a part of a first gate formed in the injection port and at least a part of a second gate formed in the resin reservoir in the resin materials, the step (d) being performed after the step (b3).

18. The method for manufacturing a rotor according to claim 16, further comprising
(e) a step for welding the core blocks adjacent to each other in the axial direction before the step (b2).

19. The method for manufacturing a rotor according to claim 16, further comprising
(f1) a step for welding a first end plate to an end surface of the first core block on the first side in the axial direction before the step (b2), the first end plate having a first connection hole communicating with the insertion holes of the first core block.

20. The method for manufacturing a rotor according to claim 16, further comprising
(f2) a step for welding a second end plate to an end surface of the second core block on the second side in the axial direction before the step (b2), the second end plate having a second connection hole communicating with the insertion holes of the second core block.
